(19) United States
(12) Patent Application Publication
(10) Pub. No.: US 2021/0108759 A1
(43) Pub. Date: Apr. 15, 2021

(54) Adjustable Grab Bar Apparatus

(71) Applicant: Your Mobility Innovations Inc., Frankford (CA)

(72) Inventors: Brett Lyons, Frankford (CA); Jonathan M. Clark, Toronto (CA); Sean S.L. Monteiro, Calgary (CA); Ashton J. Stoop, Ajax (CA)

(21) Appl. No.: 16/498,021

(22) PCT Filed: Apr. 4, 2018
(86) PCT No.: PCT/CA2018/050413

§ 371 Date: Sep. 26, 2019

Related U.S. Application Data
(60) Provisional application No. 62/481,152, filed on Apr. 4, 2017.

(51) Int. Cl. F16M 13/02; G05G 1/08; A47K 17/02

(52) U.S. Cl. CPC F16M 13/022; F16H 19/04; A47K 17/022; G05G 1/085

(57) ABSTRACT

The invention provides an adjustable grab bar apparatus that allows a user to easily and quickly position the grab bar to suit his/her particular requirements and capabilities, without the need for tools and/or additional hardware. Adjustment may be done by users with impaired dexterity and/or limited strength, since adjustment is accomplished using a simple interface such as a manual crank, a switch (e.g., push-button or touch sensitive), a foot pedal, etc. Embodiments include a self-locking feature wherein the grab bar remains secure at any user-selected position, and adjustment is a simple one-step procedure in that there is no need to disengage a locking mechanism prior to adjusting the grab bar position and/or engage a locking mechanism after adjusting the grab bar position.

### FIELD

The invention relates to grab bars used as aids by the elderly and by persons with disabilities. In particular, the invention relates to a grab bar apparatus wherein the position of the grab bar is easily and quickly adjusted, and is self-locking at any selected position.

### BACKGROUND

Grab bars of various designs, structures, sizes, and finishes are commonly installed in bathrooms and other rooms of homes or facilities to aid elderly persons and persons with disabilities. These are generally mounted to a fixed location on a wall, ceiling, or floor proximate to where they are needed, to help such persons access a toilet, bathtub, bed, stairs, etc. Some existing grab bar designs are said to be adjustable in position and/or height. The adjustment may require tools and at least partial dismounting and remounting of one or more components to reposition the grab bar to its new position and/or height. Other designs may be more conveniently adjusted. For example, a currently-available bathtub grab bar employs a stainless steel locking mechanism to adjust height. However, the locking mechanism is difficult to operate by a person with limited dexterity or strength, and generally requires the assistance of a second person. Also known are flip-up safety bars and rails; however these also employ locking mechanisms that present obstacles to individuals with limited dexterity or strength, or with disabilities. Thus, although some prior grab bar designs include a user-adjustable feature, these often cannot easily be adjusted by the intended users on an as-needed basis to meet specific requirements.

### SUMMARY

According to one aspect of the invention there is provided an adjustable grab bar apparatus, comprising: a first member having a first end that is adapted to be fixed to a substrate, and a second end; a second member that engages the first member, wherein longitudinal axes of the first member and the second member are substantially aligned; a drive mechanism that is adapted to propel the second member relative to the first member in first and second directions that are substantially parallel to the longitudinal axes of the first member and the second member; and a grab bar attached to a location on the second member such that the grab bar is propelled together with the second member in the first and second directions; wherein the drive mechanism is self-locking.

According to another aspect of the invention, there is provided an adjustable grab bar apparatus, comprising: a first member comprising a support structure that is adapted to be attached to a surface; a drive mechanism fixed to the first member, the drive mechanism being adapted to engage a second member and to advance and retract the second member relative to the first member; and a grab bar attached the second member such that the grab bar is advanced and retracted together with the second member; wherein the drive mechanism is self-locking.

According to one embodiment, the grab bar is raised when the second member is advanced and is lowered when the second member is retracted.

According to various embodiments, the drive mechanism may comprise a gear train, and the gear train may comprise a worm and a worm gear.

According to various embodiments, the drive mechanism may comprise a manual crank or a handwheel.

In one embodiment, the drive mechanism comprises a gear train and an actuator.

In one embodiment, the gear train comprise a worm and a worm gear.

In one embodiment, the actuator comprises a manual crank that drives the worm.

In one embodiment, the drive mechanism comprises an electric motor.

In one embodiment, the drive mechanism comprises an electric motor that drives the worm.

In one embodiment, the actuator includes at least one switch that controls the electric motor, to control propelling the second member in the first direction and second direction.

In one embodiment, the drive mechanism comprises a pressure sensitive mechanism.

In various embodiments, the pressure sensitive mechanism is selected from a hydraulic mechanism and a pneumatic mechanism.

In various embodiments, the actuator includes one or more of a switch, wireless communication, voice activation, proximity sensing, and motion sensing.

According to another aspect of the invention there is provided a method for implementing a grab bar apparatus, comprising: providing a first member having a first end that is adapted to be fixed to a substrate, and a second end; providing a second member that engages the first member, wherein longitudinal axes of the first member and the second member are substantially aligned; attaching the grab bar to a location on the second member; using a drive mechanism to propel the second member relative to the first member in first and second directions that are substantially parallel to the longitudinal axes of the first member and the second member; and wherein propelling the second member in the first direction or the second direction adjusts a position of the grab bar; wherein the drive mechanism is self-locking.

According to another aspect of the invention there is provided a method for implementing a grab bar apparatus, comprising: providing a first member comprising a support structure that is adapted to be attached to a surface; fixing a drive mechanism to the first member, the drive mechanism being adapted to engage a second member and to advance and retract the second member relative to the first member; and attaching the grab bar to the second member such that the grab bar is advanced and retracted together with the second member; wherein the drive mechanism is self-locking.

According to one embodiment, the method includes raising the grab bar when the second member is advanced and lowering the grab bar when the second member is retracted.

According to various embodiments, the method may include using a drive mechanism comprising a gear train, and the gear train may comprise a worm and a worm gear.

According to various embodiments, the drive mechanism may comprise a manual crank or a handwheel, an electric motor, or a pressure sensitive mechanism such as a hydraulic mechanism or a pneumatic mechanism.

Further methods relate to implementing an adjustable grab bar apparatus in accordance with the embodiments described herein.

### BRIEF DESCRIPTION OF THE DRAWINGS

For a better understanding of the invention and to show more clearly how it may be carried into effect, reference will be made, by way of example, to the accompanying drawings, wherein:

FIG. 1 is a diagram showing a generalized embodiment;

FIG. 2A is a diagram of an embodiment implemented with a manual crank handle for height adjustment;

FIG. 2B shows details of a gear train configuration suitable for the embodiment of FIG. 2A;

FIG. 2C shows further details of the embodiment of FIG. 2B;

FIGS. 3A and 3B are diagrams showing another embodiment; and

FIG. 4 shows details of an embodiment implemented with an electric motor.

### DETAILED DESCRIPTION OF EMBODIMENTS

There are deficiencies in existing adjustable grab bar designs that may present difficulties to users. For example, an adjustable feature may require more dexterity or strength than a user is capable of exerting. Alternatively, or additionally, an adjustable feature may not result in correct positioning of the grab bar for all possible users. For example, a person in a wheelchair may require a grab bar at a different height than a person using crutches or a walker. As a result, the specific needs of individuals with physical disabilities often are not met by existing grab bars, which is a significant inconvenience, and in some cases this may dissuade such individuals from going out into their communities.

Embodiments described herein address such deficiencies. According to the embodiments, an adjustable grab bar apparatus is provided that allows a user to easily and quickly position the grab bar to suit his/her particular requirements and capabilities. Embodiments may be used in private homes, retirement and nursing homes, hotels, hospitals, gyms, swimming pools, public facilities, garages, outdoors or indoors, etc. The ease of use of embodiments described herein results in greater independence and confidence in disabled and elderly persons, removing negative factors such as a fear of falling and possible embarrassment, which encourages them to be more outgoing.

Embodiments described herein are easily adjusted by a user without the need for tools and/or additional hardware. Moreover, adjustment may be done by users with impaired dexterity and/or limited strength, since adjustment is accomplished using a simple interface such as a manual crank, a switch (e.g., push-button or touch sensitive), a foot pedal, etc. A feature of the invention is that adjustment of the grab bar is made without the requirement of additional steps or hardware for unlocking and/or locking the grab bar position. That is, embodiments include a self-locking feature wherein the grab bar remains secure at any user-selected position, and adjustment is a simple one-step procedure in that there is no need to disengage a locking mechanism prior to adjusting the grab bar position and/or engage a locking mechanism after adjusting the grab bar position.

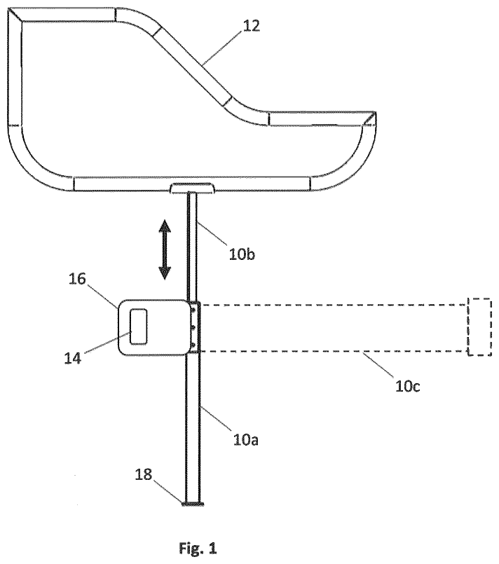

A generalized embodiment will now be described with reference to FIG. 1. Main components include a support structure with members 10a and 10b, a grab bar 12, an actuator 14, and a drive mechanism 16. These components may be made of the same or different materials, such as metal, fiberglass, plastic, etc. In installations where the apparatus may come into contact with moisture or where it is installed outdoors, it is preferable that the materials are suitably non-corrosive, such as stainless steel, aluminum, plastic, or fiberglass. The first member 10a of the support structure may include one or more of a number of possible attachment configurations for attaching the structure to a solid substrate or surface, such as a floor or a wall. For example, a flange 18 may be provided with holes to accommodate screws. The specific arrangement of the flange 18 or other attachment configuration may be determined by whether the grab bar apparatus is installed during new construction, or as a retrofit in an existing facility. In some embodiments, the support structure may include one or more additional member 10c, adapted to be attached to an adjacent wall or other solid surface to provide additional stability.

The grab bar 12 is attached to the second member 10b of the support structure. Preferably, the surface of the grab bar is mostly or completely finished as a slip-resistant surface. For example, the surface may be knurled to enhance grip, or a rubber material or other material may be disposed on the surface. The grab bar may of course be any suitable shape for a given installation or application; the design shown in the figures being merely representative. However, it is noted that the grab bar design shown in the figures has been found well-suited for use in washrooms, and it accommodates a wide range of sizes of users.

The second member 10b of the support structure is moveable along its longitudinal axis. Thus, the second member may be advanced and retracted relative to the drive mechanism 16 to provide height adjustment, shown by the double-ended arrow in FIG. 1, of the grab bar 12. The amount of height adjustment provided may depend on the specific application. As one example suitable for use beside a toilet, the height adjustment may range from about 16-44 inches (about 40-112 cm). In one embodiment, the first member 10a internally accommodates the second member 10b, so that the two members cooperate telescopically and substantially coaxially. In other embodiments, the second member 10b may be accommodated on the outside of the first member 10a, such that the two members cooperate along their substantially parallel longitudinal axes. The members 10a and 10b are provided with suitable guides, bushings, bearings, rollers, etc. to facilitate the relative movement. Outer covers, bellows, etc. may be provided to protect the members from elements and contamination, as well as to prevent clothing, fingers, etc. from being caught.

The actuator 14 and drive mechanism 16 may be mounted on member 10a of the support structure. As used herein, the term “actuator” refers to a part of the apparatus that a person uses to adjust the position of the grab bar. For example, an actuator may be a crank handle, a hand wheel, a lever, a switch such as a push button, a foot pedal, etc. In some embodiments, the actuator may comprise a software application executable on a mobile computing device, such as a smartphone.

The drive mechanism may be based on any one of a number of suitable technologies. In one embodiment the drive mechanism may be implemented with a gear train that includes a rack and pinion. For example, the rack may be disposed on the second member 10b of the support structure, and the pinion disposed in a housing that is secured to member 10a, together with the actuator 14.

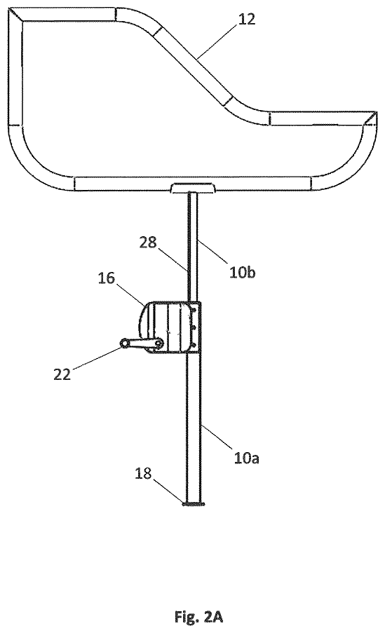

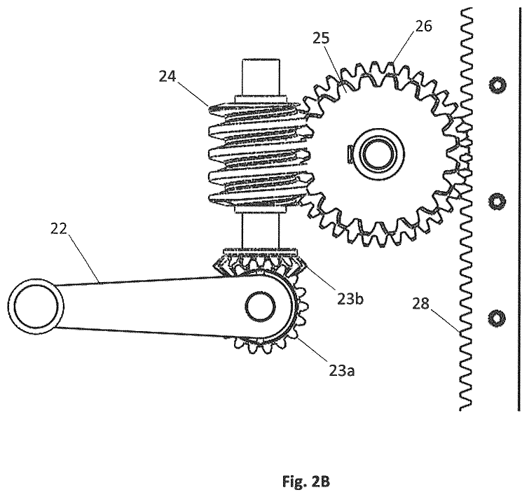

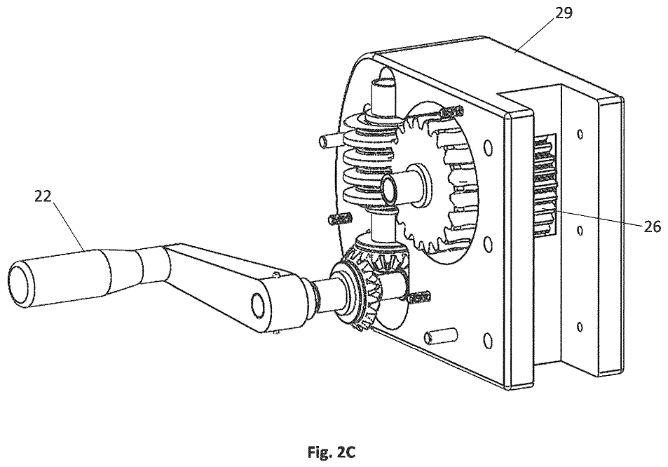

FIGS. 2A-2C show an embodiment wherein the drive mechanism 16 is implemented with a gear train including a rack and pinion. In this embodiment the rack 28 is disposed on the second member 10b of the support structure. As shown in detail in FIG. 2B, the gear train includes a worm 24 that drives a worm gear 25, thus driving the pinion 26 which engages the rack 28. In this embodiment the actuator is implemented with a manual crank handle 22, which is implemented using conical gears 23a, 23b to drive the worm 24. FIG. 2C shows the drive mechanism assembled in a housing 29, with the cover removed. It will of course be appreciated that variations of the gear train may be implemented. The crank handle 22 may be configured to fold out of the way when not in use. A manually-operated actuator such as the crank handle of this embodiment, or, e.g., a lever, advantageously does not require other power input (such as electricity), and is generally considered to be low-maintenance. It will be appreciated that the gear train of this embodiment, which includes a worm 24 and worm gear 25, provides a self-locking mechanism that secures the position of the grab bar. Accordingly, the grab bar will not move upwards when pulled upwards and will not move downwards when downward pressure is applied to it.

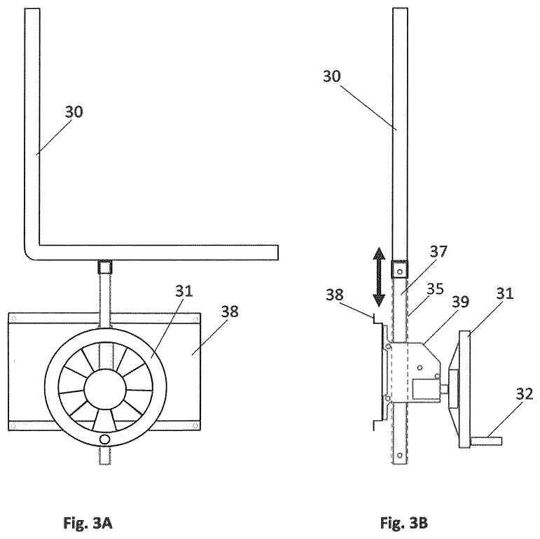

FIGS. 3A and 3B show two views of another embodiment configured for manual operation. Main components of this embodiment include the grab bar 30, a member 37, a housing 39 for a drive mechanism, and a member including a bracket 38. The bracket 38, which supports the embodiment, is suitably adapted for attachment to a wall, and thus avoids the need for any component to contact the floor. The drive mechanism housing 39 is mounted on the bracket 38. The drive mechanism may be implemented using a gear train. For example, the gear train may include a self-locking rack and pinion such as that used in the embodiment shown in FIG. 2B. In this embodiment the drive mechanism is actuated using a hand wheel 31, optionally including a handle 32. The rack may be incorporated into the member 37, thus, rotating the handwheel 31 moves the member 37 up and down substantially vertically, as showing by the double-ended arrow, to raise and lower the grab bar 30. Since the handwheel may be gripped anywhere about its circumference, it is more convenient to use than a simple crank handle which may be difficult to reach or operate when at certain positions. The handwheel may have a textured or coated surface that improves the user's grip. A cover 35 disposed over the rack of the member 37 protects from elements and contamination, as well as prevents clothing, fingers, etc. from being caught.

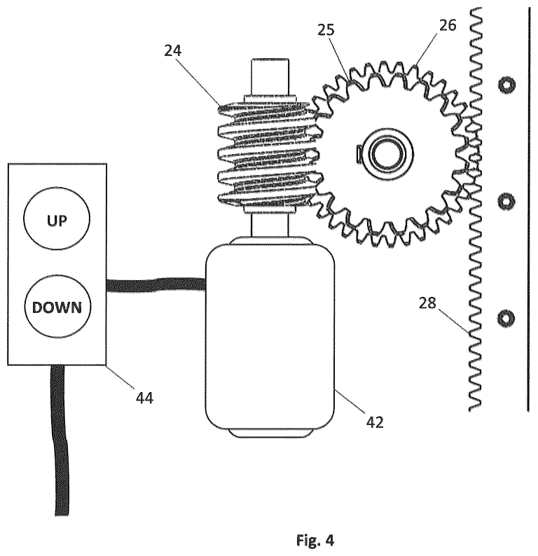

FIG. 4 shows an embodiment wherein the drive mechanism 16 is implemented with a gear train including a rack and pinion, and an electric motor 42. In this embodiment the rack 28 is disposed on the second member 10b of the support structure, and the electric motor 42 drives the worm 24. The actuator is implemented with a switch module 44 which may include one or more of, e.g., a push-button switch, a touch-sensitive switch, a foot switch, etc. to activate the electric motor and control up and down adjustments of the grab bar. The switch module may include a motor controller. In various embodiments, the controller may include electronic circuitry that performs or is associated with one or more functions such as, but not limited to, power conversion (e.g., AC-DC conversion), logic operations, processing (e.g., a microprocessor), voice activation, motion sensing, and communications (e.g., wireless communications such as infrared, Bluetooth®). Wireless communications may allow a user to adjust the grab bar position using an application running on a smartphone or other device, and may provide other functions such as providing a message to a monitoring facility indicating, e.g., a problem with the apparatus, a need for service or maintenance, etc. The electric motor may be a servo motor that allows adjustments to be made incrementally. This embodiment provides self-locking of the drive mechanism at any user-selected grab bar position, as described above. It will of course be appreciated that variations of the motor and gear train arrangement may be implemented.

In other embodiments the drive mechanism may include a pressure-sensitive component, such as a pneumatic mechanism or a hydraulic mechanism. In such embodiments an actuator may include one or more feature that facilitates grab bar position adjustment by a user, similar to those discussed above in respect of an implementation using an electric motor (e.g., a switch (push-button, slider, touch-sensitive, foot-operated, etc.), voice activation, motion sensing, wireless communications). Embodiments include the feature that the drive mechanism is self-locking, such that it automatically maintains the adjusted position selected by the user, without the need for a locking mechanism.

Embodiments have been described primarily with respect to raising and lowering a grab bar, i.e., adjusting the height of a grab bar. This corresponds to moving the grab bar substantially along the vertical or axis of a three-axis coordinate system. It will be appreciated that the approaches described herein, or variants thereof, may be configured to advance and retract a grab bar in a horizontal direction, i.e., along a horizontal axis of a three-axis coordinate system.

### EQUIVALENTS

It will be understood by those skilled in the art that this description is made with reference to certain embodiments and that it is possible to make other embodiments employing the principles of the invention which fall within its spirit and scope as defined by the claims.

1. An adjustable grab bar apparatus, comprising:
a first member comprising a support structure that is adapted to be attached to a surface;
a drive mechanism fixed to the first member, the drive mechanism being adapted to engage a second member and to advance and retract the second member relative to the first member; and
a grab bar attached the second member such that the grab bar is advanced and retracted together with the second member;
wherein the drive mechanism is self-locking.

2. The adjustable grab bar of claim 1, wherein the grab bar is raised when the second member is advanced and is lowered when the second member is retracted.

3. The adjustable grab bar of claim 1, wherein the drive mechanism comprises a gear train.

4. The adjustable grab bar of claim 3, wherein the gear train comprise a worm and a worm gear.

5. The adjustable grab bar of claim 1, wherein the drive mechanism comprises a manual crank.

6. The adjustable grab bar of claim 1, wherein the drive mechanism comprises a handwheel.

7. The adjustable grab bar of claim 3, wherein the drive mechanism comprises a manual crank or a handwheel.

8. The adjustable grab bar of claim 1, wherein the drive mechanism comprises an electric motor or a pressure sensitive mechanism.

9. The adjustable grab bar of claim 8, wherein the pressure sensitive mechanism is selected from a hydraulic mechanism and a pneumatic mechanism.

10. The adjustable grab bar of claim 8, comprising an actuator including one or more of a switch, wireless communication, voice activation, proximity sensing, and motion sensing.

11. A method for implementing a grab bar apparatus, comprising:
providing a first member comprising a support structure that is adapted to be attached to a surface;
fixing a drive mechanism to the first member, the drive mechanism being adapted to engage a second member and to advance and retract the second member relative to the first member; and
attaching the grab bar to the second member such that the grab bar is advanced and retracted together with the second member;
wherein the drive mechanism is self-locking.

12. The method of claim 11, comprising raising the grab bar when the second member is advanced and lowering the grab bar when the second member is retracted.

13. The method of claim 11, wherein the drive mechanism comprises a gear train.

14. The method of claim 11, wherein the gear train comprise a worm and a worm gear.

15. The method of claim 11, wherein the drive mechanism comprises a manual crank.

16. The method of claim 11, wherein the drive mechanism comprises a handwheel.

17. The adjustable grab bar of claim 13, wherein the drive mechanism comprises a manual crank or a handwheel.

18. The method of claim 11, wherein the drive mechanism comprises an electric motor or a pressure sensitive mechanism.

19. The method of claim 18, wherein the pressure sensitive mechanism is selected from a hydraulic mechanism and a pneumatic mechanism.

20. The method of claim 18, comprising using one or more of a switch, wireless communication, voice activation, proximity sensing, and motion sensing to control the drive mechanism.
